(19) United States
(12) Patent Application Publication
(10) Pub. No.: US 2011/0185661 A1
(43) Pub. Date: Aug. 4, 2011

(54) Window frame, method for fitting a window, foam sealing strip, method for sealing a window frame and container with foam sealing strip

(75) Inventors: Helmar Nauck, Berlin (DE); Markus Komma, Regenstauf (DE); Frank Wörmann, Bergkamen (DE)

(73) Assignee: TREMCO ILLBRUCK PRODUKTION GMBH, Bodenwohr (DE)

(21) Appl. No.: 12/989,718

(22) PCT Filed: Mar. 26, 2009
(86) PCT No.: PCT/EP09/53599

§ 371 Date: Apr. 21, 2011

(30) Foreign Application Priority Data
Apr. 28, 2008 (DE) 10 2008 021 215.6
May 24, 2008 (DE) 10 2008 025 019.8

(51) Int. Cl. E06B 3/263; E04B 1/66; E04C 2/20; E06B 1/36

(52) U.S. Cl. 52/309.4; 52/741.1; 52/656.5; 52/745.15

(57) ABSTRACT

The invention relates to a window (1) comprising a frame (2), wherein a sealing strip (3) made of an elastic, optionally, resilient foam is applied to the outer side of the window frame (2). The aim of the invention is to provide a window frame that is used to construct a window, a sealing strip made of an elastic resilient foam being applied to the outer side of said window frame that can be inserted in an advantageous manner during simple pre-assembly. The invention is characterised in that the foam is maintained in the compressed form on the window frame (2) by means of a holding part (4) and precompression can be released by destructive effects on said holding part (4) that is elastically prestressed in the direction of extension or that is made of a brittle material.

The invention relates in first instance to a window frame used for forming a window, a sealing strip of an elastic foam, possibly impregnated for delayed shape recovery, being disposed on the outside of the window frame.

A window frame of this type and a sealing strip disposed in a frame profile of the window frame are known, for example, from EP 1 811 111 A2. In addition, it is known from DE 10 2005 058 414 A1 to fix to a window frame a sealing strip held in a compressed form in a film wrapping, by means of a holding strip attached to the frame. The fixing takes place by adhesive bonding in the holding strip. After fixing to the holding strip, the film wrapping is broken open by pulling the tear-open tab, and this allows the foam to recover its shape. In the case of the known window frame and in the case of the known way in which the sealing strip is kept compressed in a film, the mounting and activation of the sealing strip on a window frame of such a configuration is still relatively laborious.

It is accordingly an object of the invention to provide a window frame that can be used for forming a window, a sealing strip of foam that can elastically recover its shape being disposed on the outside of the window frame, it being possible for the sealing strip to be advantageously installed together with the window by simple pre-assembly.

According to a first aspect of the invention, one possible way of achieving the object is provided by the subject matter of claim 1, it being provided in this case that the foam is held in a compressed form on the window frame by means of a retaining part and that the pre-compression can be released by destructive action on the retaining part, the retaining part secured to the window frame additionally bringing about the compression of the foam supported on the other side on the window frame itself. There is no need for wrapping of the sealing strip and securing of the sealing strip, in a wrapping, to the window frame. Rather, by directly securing the retaining part to the window frame, the sealing strip is enclosed in a compressed form between the retaining part and the window frame. Such a retaining part can be destroyed in particular in a simple way, without for instance the retaining part first having to be separately removed, for example, in the course of the customary fitting of the window, during which fixing screws are driven through the frame in the transverse direction. For this purpose, the retaining part is disposed correspondingly in line with regions of the window frame that are used for placement of the fixing screws.

The retaining part may preferably be of an elastically prestressed form. It may, however, also consist of brittle material. Both in the case of the elastically prestressed form and in the case of the brittle material, there comes about a tearing open or breaking open of the retaining part, in the form of individual fragments or torn-off parts, so that, in spite of a destructive action perhaps only being applied to the retaining part at certain points, the pre-compression of the foam strip is released over the entire length of the window frame and the foam strip accordingly comes into retainer holders against the window reveal. The destructive action may also be applied separately, for instance by using a knife or pick on the retaining part, for instance when the window frame is already inserted, but the mounting screws mentioned have not yet been driven through or, although the mounting screws are in place, the sealing strip has not yet been fully released as desired. The elastic prestressing in the direction of extent may accordingly be provided both in the transverse direction of the window frame, that is to say over the depth of the window frame with respect to the retaining part, and over the height, that is to say over the length of the retaining part, also, furthermore, with a certain combination of the two prestressing directions.

In the case of the elastic material, a certain, perfectly acceptable, pre-bulging of the retaining part will occur as a result of the elasticity of the material with regard to the expandable elastic foam held back by it. Suitable for example as the elastic material is a plastics film, which may furthermore be mounted directly on the window frame or on an accommodating part (container) for the foam sealing part, for example by adhesive bonding or fusing. The recovering or re-expanding parts of the retaining part may be cut off or collected up or else, as further explained in detail below, left behind on site without any problem, at least if the material forming the retaining part is chosen appropriately.

Further features of the invention are explained below, including in the description of the figures, often in their preferred association with the claim concept already discussed above, but they may also be important in association with just one or more than one feature of this claim or independently.

It is particularly preferred that, if the retaining part is arranged in a flexible and stressed manner, the pre-compression being releasable by break-up of the retaining part, as mentioned, for instance by using a knife or pick, preferably, however, by impact from the window frame side, that is to say to the retaining part from the inside, for instance by means of one of the fixing screws already mentioned. A fixing screw therefore passes initially through the window frame, then the foam strip in a compressed form, after which it meets the retaining part from below and then passes destructively through it. The same may also be provided in the case of a retaining part consisting of brittle material or under tearing-open prestressing, the pre-compression being releasable by breaking the brittle retaining part or tearing open the retaining part.

Preferably, and as also known per se, the window frame comprises a profiled part, which already forms a corresponding holder, trough-like in cross-section, for the sealing strip. In fact, it may be an outwardly opening profiled pocket.

It is also preferred that the retaining part is connected to the profiled pocket, suitably to side walls of the profiled pocket. In this case, these pocket walls formed as side walls may serve as retainer holders for the retaining part. Consequently, no special fixing is required, but instead the retaining part may for example be pushed in like a slide in the course of production of the window, if the pocket walls for example provide retainer holder lugs. The fixing of the retaining part is then readily obtained as a result of the outwardly acting compressed foam.

In further detail, it is preferred that a retainer holder comprises a hook-like projection.

The retainer holders may also be provided by film strips, for example adhesive strips. The film strip may also, for example, be connected to the retaining part and/or the window frame by tack-welding.

In addition, it is also preferred that the retaining part consists of a biodegradable material. In particular in this connection, the already mentioned practice of leaving on site fragments arising after fitting of the window is readily possible.

The retaining part may be formed in the simplest way as a flat part, for example in the form of a plate, as a whole for example in the manner of a strip.

In particular, the retaining part preferably consists at least partially of a brittle material. As known, such material is characterized in that, in a tensile test, a stress/strain diagram with a largely linear behavior up to rupture is obtained. The behavior up to rupture is also virtually or completely elastic. If relieved before rupture, there is no or virtually no hysteresis. As known, typical brittle materials are glass, ceramic or ice. It is preferred within the scope of the invention that the retaining part consists of a biodegradable material. Suitable in principle as such biodegradable material is so-called crispbread or cookie material, even if it is not appropriate to use these edible materials for this purpose. Preferred is a material based on protein-containing biopolymers, such as for instance rye meal or plant fibers, such as in particular wood fibers. If appropriate, these materials may also be in the form of a mixture. By processing in the form of a water suspension and further addition of additives such as for example lime, cork or mineral substances such as clay or earth, such mixtures can be worked into plate-like parts, preferably by heating until a saturated vapor atmosphere is achieved and subsequently extracting moisture. For further details, reference is also made to DE 10 2004 024 249 B4, in addition, to DE 10 2004 024 251 A1.

It may, in particular, also be a biodegradable plastic which is based on meal as the main component, which once again is obtained by milling fractionation from rye. The material is then in the form of granules, which can be worked in plastics extrusion machines or plastics injection-molding machines. In its finished form, the worked material then preferably has a foamy character. In particular, it may be a material such as that known under the trade name GETREX.

Furthermore, the subject matter of the invention is also a method for fitting a window in a window opening of a structure, the window having a window frame and a sealing strip of foam that can elastically recover its shape being disposed between the window frame and the window opening. With respect to such a method, reference is also made to the prior art already cited at the beginning.

On this basis, it is an object of the invention to provide an advantageous method for fitting a window with a sealing strip.

This object is achieved by a further possible solution given in the case of the subject matter of claim 14, it being provided in this case that the sealing strip is initially held on the outside of the window frame in a compressed state, by means of a retaining part fixed to the window, the compression being maintained by the retaining part together with the associated region of the window, and that, after the window is installed in the window opening, the sealing strip is released by applying destructive action to the retaining part. Specifically, reference can be made in this respect to the statements already made further above. The compression of the sealing strip is maintained on the one hand by supporting the sealing strip on the retaining part and on the other hand by supporting the sealing strip on the window frame. The retaining part can only maintain the compression of the sealing strip in conjunction with the window frame. It is accordingly preferred that the retaining part consists of an elastic material and is fitted such that it is prestressed in the direction of its extent. On the other hand, the retaining part may also be produced at least partially from a brittle material and the sealing strip may be released by breaking the brittle material.

In this way, the sealing strip can be put into the window frame and secured by the retaining part during production of the window, that is to say already at the factory. The release of the sealing strip then takes place in a simple way in the course of fitting the window, by destructive action on the, possibly brittle or elastic, retaining part, for instance by breaking, cutting or tearing into it.

Even though it is preferred in this connection that the breaking or tearing of the retaining part takes place automatically in the course of driving in the fixing screws through the window frame, as already mentioned further above, deliberate direct tearing open or deliberate direct breaking of the retaining part, for instance with a knife or a hammer, may also be carried out as a departure from this. This is so in particular if the foam sealing strip is one which is impregnated for delayed shape recovery, since the recovery then does not take place abruptly and there is still time for installation to be carried out. The destructive action is preferably effected after insertion of the window into the corresponding opening in a wall, but it is also possible to apply the destructive action before the mounting screws have been driven through the window frame into the masonry.

In a further preferred refinement of the method, it is also preferred to this extent that the retaining part consists of a biodegradable material. Reference is made to the statements made further above.

The invention also relates to a foam sealing strip suitable for sealing a window frame, in particular in a window frame as described above, or a method for fitting a window frame as described above.

The foam sealing strip is preferably impregnated for delayed recovery of shape. The foam sealing strip also has two opposite narrow sides, respectively facing the inside or the outside of a window frame in the fitted state, and wide sides, suitable for abutting against the side of a window or reveal of a window, it being possible for the narrow sides or narrow side regions to be formed differently in such a way that, in the fitted state, the one narrow side has a greater vapor-retarding effect than the other narrow side, with furthermore the greater vapor-retarding effect being achieved by a higher compression on one side of the foam in the fitted state and the higher compression on one side being achieved by an expansion material associated with this side and provided in addition to the foam.

Foam sealing strips of this type are known, for example, from EP 1 811 111 A2, the disclosure content of this document being incorporated in full in the present application, including for purposes of including features of the document referred to in claims of the present application.

With reference to such a foam sealing strip, it is an object of the invention to provide an advantageous foam sealing strip.

One possible solution to this problem is given in the subject matter of claim 19, it being provided in this case that the expansion material is expandable independently of the release of an expansion of the foam sealing strip. In the case of the known foam sealing strip, the expansion of a foam strip that is possibly provided there under the foam sealing strip on the window frame takes place at the same time as the release of the expansion of the foam sealing strip. The solution according to the invention provides, however, that the expansion of the expansion material that is additionally provided can be controlled in its timing. The expansion can then be performed when it is desired, simply for instance by the expandable material that is additionally provided being held in a wrapping which can be actively opened or destroyed separately.

Further features of the invention are explained below, including in the description of the figures, often in their preferred association with the claim concept already discussed above, but they may also be important in association with just one or more than one feature of this claim or independently.

It is thus preferred that the expansion material is disposed in the form of a strip in or under the foam of the foam sealing strip.

It is also preferred that the expansion material expands as a result of moistening. Materials that can expand as a result of moistening are variously known. For example, reference is made to clay materials that expand when exposed to moisture, such as for instance bentonite.

The characterizing of the foam sealing strip with respect to a wide side and a narrow side is only for the purpose of identifying the sides referred to with regard to the fitted state. In principle, the wide side may also be narrower than the narrow side.

The invention also relates to a method for sealing a window frame with respect to a window reveal by means of a foam sealing strip, which is preferably impregnated for delayed recovery of shape, the foam sealing strip having two opposite narrow sides, respectively facing the inside or the outside of the window frame in the fitted state, and wide sides, suitable for abutting against the side of a window or reveal, it being possible for the narrow sides or narrow side regions to be formed differently in such a way that, in the fitted state, the one narrow side has a greater vapor-retarding effect than the other narrow side, and furthermore the higher compression on one side being achieved by an expansion material associated with this side, provided in addition to the foam and able to expand when expansion is initiated.

In the case of the known method, the expansion material is released for expansion in the course of unwinding for example from a roll of the foam sealing strip, which is in a compressed form on the roll. In this case, no influence can be brought to bear on the expansion, that is to say in particular at the point in time of the expansion. This known expansion material is itself an elastically shape-recovering foam.

On the basis of the known method, it is to this extent an object of the invention to provide a method for sealing a window frame, it being possible to deliberately carry out the different forming of one narrow side region compared with the other narrow side region.

One possible solution for achieving this object is given in the case of the subject matter of claim 23, it being provided that the expansion of the additional expansion material can be carried out independently of an expansion of the foam strip by moistening of the additional expansion material. This allows the fitting to be performed initially in the customary way, without the differing vapor permeability already being set up. This can then be performed deliberately, for instance by spraying with water. It is evident that any materials that swell when moisture is added are suitable as additional expansion material. Here too, reference can be made again to the material already mentioned, bentonite, or more generally to swelling clay materials.

It is particularly preferred that the moistening is performed through the foam of the foam sealing strip. This is quite possible, since the foam is usually an open-pore foam, at least whenever it is impregnated for delayed recovery of shape.

A further subject matter of the invention is a foam sealing strip held in a compressed form in a container, the container having a container cover. Containers of this type are known in various embodiments in the form of strips, in which an elastic foam sealing strip, preferably impregnated for delayed recovery of shape, is held. The container cover may, for example, be snap-fitted in place and deliberately opened after fitting, in the case of the known strip containers, for instance by a film wrapped around the cover on one side and extending into the inside of the strip container, the cover being opened when the film is pulled.

To this extent, it is an object of the invention to provide an advantageous container of this type.

One possible solution for achieving this object is given in the subject matter of claim 26, it being provided that the pre-compression of the foam sealing strip can be relieved by destructive action on the retaining part arranged in an elastically stressed manner in its extent or consisting of a brittle material. For further details of such a cover, reference is made to the statements made above concerning the brittle or elastic retaining part. In particular, such a container is also intended to be used for attachment to a window frame, so that a container attached in such a manner then has properties and possibilities for use such as those described above with respect to the window frame already connected to such a sealing strip holder. The statements made therefore also apply in the context described here.

To this extent, it is preferred that the container has attaching elements. These may be formed, for example, as adhesive strips or else as latching attaching elements, to be specific, such latching attaching elements as are adapted to corresponding receiving latching means on a narrow side of a window frame. In a further detail, the foam sealing strip may then also have one or more of the features already described above, that is to say for instance be lined on one side with an expansion material that can be deliberately induced to expand, for instance by moistening. It may also inherently have differing compression, for instance by the base of the container being configured differently over the width, and this compression is retained in this differing form with the often incomplete recovery of shape in the fitted state.

The invention is further explained below with reference to the accompanying drawing, which however merely represents an exemplary embodiment and in which:

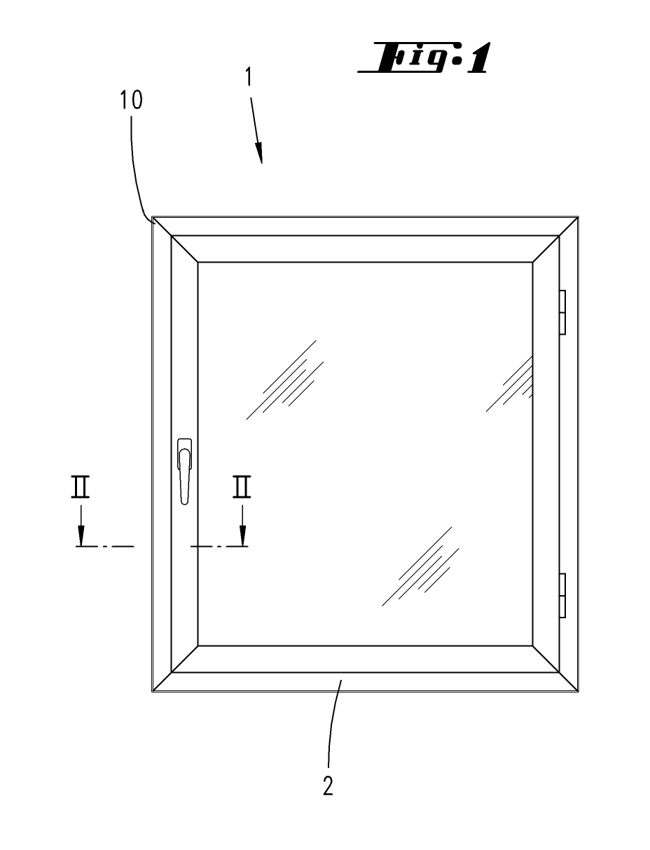

FIG. 1 shows a plan view of a window with a window frame;

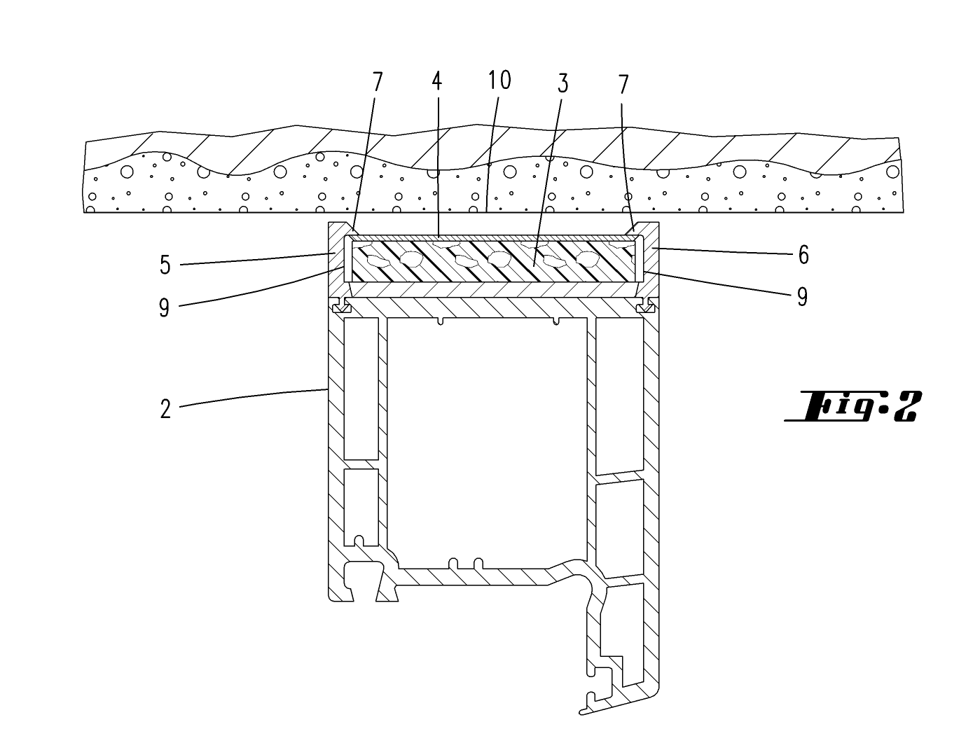

FIG. 2 shows a cross-section through the window frame according to FIG. 1;

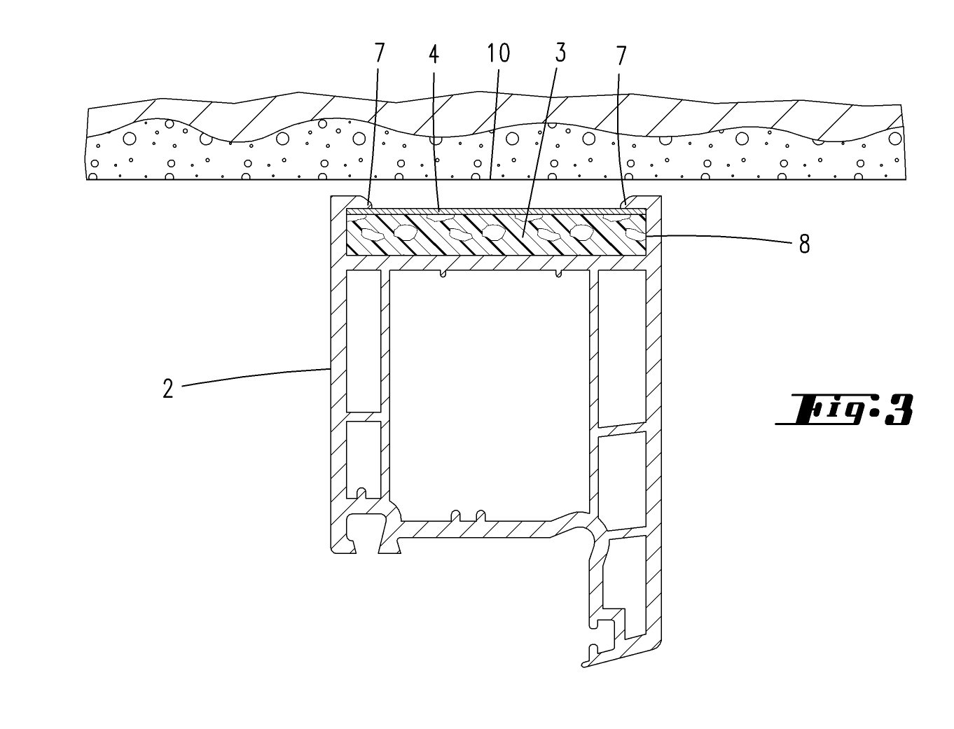

FIG. 3 shows a cross-section through the window frame after fitting in an opening in a wall, before driving in a fixing screw;

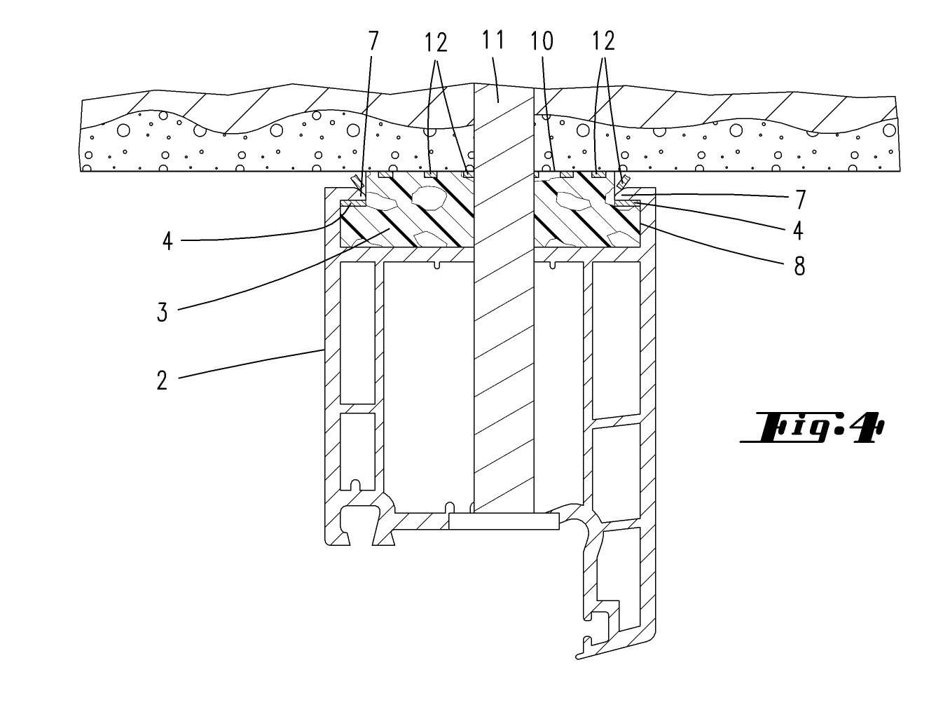

FIG. 4 shows a representation according to FIG. 3 after driving in the fixing screw; and

FIG. 5 shows an alternative embodiment of the window frame and of the sealing strip accommodated therein with an additional expansion material, in a representation according to FIG. 2;

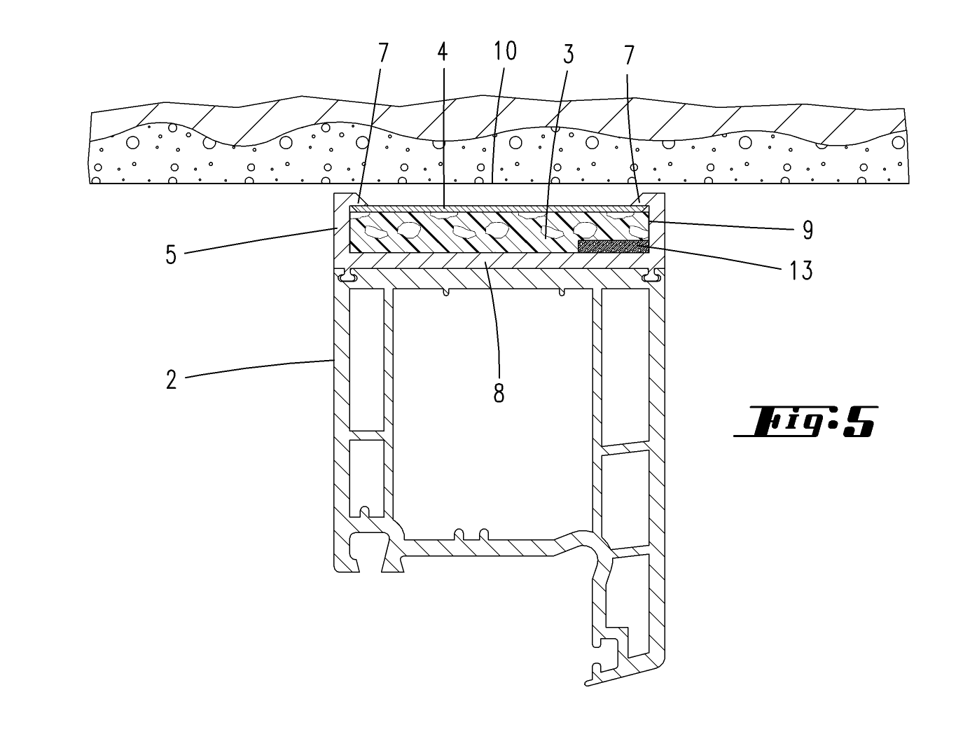

FIG. 6 shows a representation of the subject matter according to FIG. 5 in a state according to FIG. 4 and after expansion of the additional expansion material;

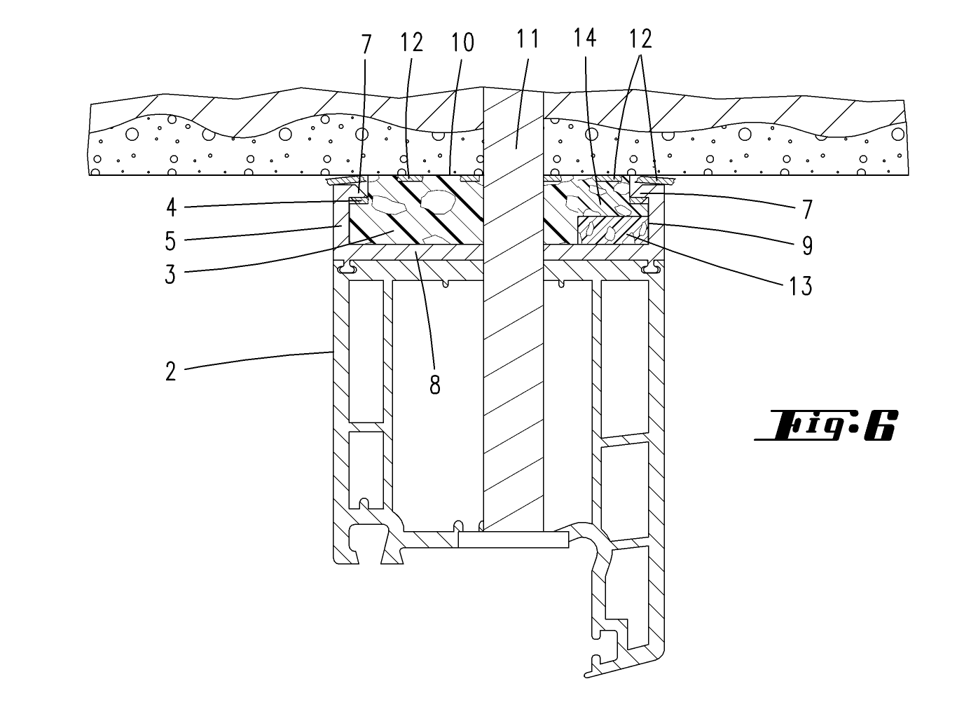

FIG. 7 shows a foam sealing strip container in cross-section;

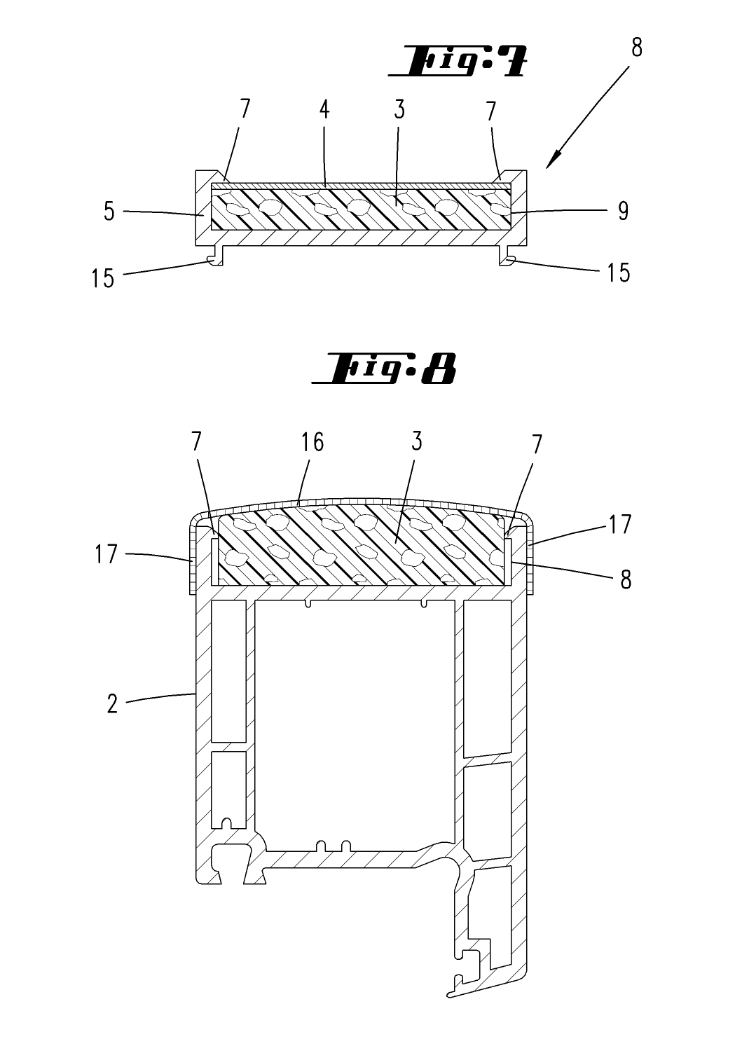

FIG. 8 shows a representation according to FIG. 3, the retaining element comprising a film secured on the outside of the window frame;

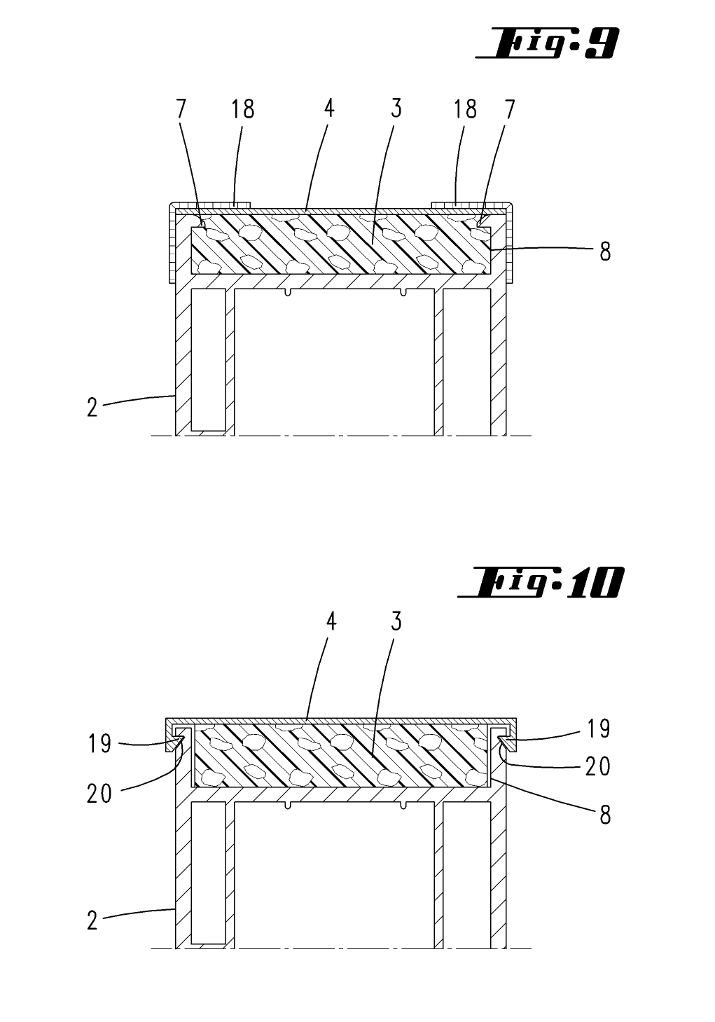

FIG. 9 shows a representation according to FIG. 3, the retaining element being secured on the outside of the window frame by means of film strips; and

FIG. 10 shows a representation according to FIG. 3, the retaining element being connected to the outside of the window frame by clips.

Shown and described is a window 1 with a window frame 2 (FIG. 1), a sealing strip 3 formed from an open-cell elastic foam impregnated for delayed shape recovery being disposed on the outside of the window frame 2 (see FIG. 2). The sealing strip is secured in a compressed form on the window frame 2 by means of a retaining part 4. The sealing strip is captured in this state between the retaining part 4 and the window frame 2. It is supported both on the retaining part 4 and on the window frame 2. The retaining part 4 consists at least partially of a brittle material, so that it can for example be made to break up by impact loading.

It is evident that the window frame 2 comprises a profiled part, to be specific in a known way a plastics extruded profiled part. On the extruded profiled part (FIGS. 3, 4) there are retainer holders 5, 6, whether formed directly on it as inserted profiled parts (FIG. 2) or mounted as a separate mating part (FIGS. 5, 6), in the case of the exemplary embodiment, for example, snap-fitted in place. The retainer holders 5, 6 respectively form hook-like projections 7 facing inward, i.e. toward one another, against which the retaining part 4 engages from below as a result of a prestressing exerted by the foam 3. Sufficient fixing of the retaining part 4 in relation to the window frame 2 is achieved in this way. In the case of the exemplary embodiment of FIGS. 3, 4, the projections 7 are formed integrally on the profile.

In a further detail, the sealing strip 3 may lie in the window frame in a profiled pocket 8 formed therein. In the case of the exemplary embodiment of FIG. 2, it is further held between wall regions 9 of the retainer holders 5, 6. The sealing strip 3 engages in the outward direction against the underside of the retaining part 4. As is evident, the retaining part 4 is elongate like a plate, formed with a length which respectively corresponds to an edge length of the window profile, on the outside. In a way not shown in detail, crossing insertion grooves, into which a retaining part can be respectively pushed, may be formed at corner regions 10 of the window frame 2.

It is preferred, however, that it is latched in place from the outside by the clipping-in method, while overcoming the projections 7. For this purpose, the projections 7 as such or altogether, including the retainer holders 5, 6, may be flexibly formed. The flexibility may also be provided in the retaining part 4 itself.

As a departure from the configuration represented, the retaining part 4 may also be configured for example such that it is curved in the transverse direction, preferably in such a way that it is externally concave. This is also to allow it, where applicable, to be better able to accept compressive stresses, such as are exerted by the sealing strip 3.

To produce a window frame of this type and install it, the preferred procedure is that first the window is assembled with the window frame 2 at the factory in the customary way from plastics profiled parts, although wooden profiled parts may also be used. Then, the sealing strip 3 is inserted in the compressed state. This may also be with the assistance of a, for example, knife-like auxiliary part, which maintains the compression until the retaining part 4 is inserted, which takes place in the next step. Such an auxiliary part could then be withdrawn again in the longitudinal direction. Finally, the foam finally engages against the retaining part 4 from below under expansion pressure. In this form, the window frame or the window is inserted into a corresponding opening 10 in a wall, see FIGS. 3, 4, of a structure. In a customary way, the window frame 2 is mounted in the opening 10 in the wall or mounted in the adjacent masonry by means of fixing screws 11. In the course of driving in the fixing screws 11, which are also pushed through the sealing strip 3, the screws destroy the brittle retaining part 4, so that the expansion of the sealing strip 3 is automatically released as a result and the abutment of the sealing strip 3 on the window reveal is obtained in the desired way, see FIG. 4. When this happens, fragments 12 of the retaining part 4 may also remain between the sealing strip and the reveal.

In the arrangement according to FIG. 5, there is inserted under the sealing strip 3, on the bottom of the profiled pocket part 8 that is latched in place on the window frame 2, an expandable part 13, which in the case of the exemplary embodiment is represented in the manner of a flat strip. The expandable part 13 is preferably much thinner than how it is shown in FIG. 5. Therefore, the insertion as such does not generally achieve any significant greater compaction in the associated edge region of the sealing strip 3. This part may also consist of a biodegradable material, as explained in detail above. A pertinent aspect is that the material can be made to expand by moistening. Also in this respect, reference is made to the statements made further above. In the expanded state, it retains its expanded position. The expanded position is represented in FIG. 6. As a result, the region 14 of the sealing strip extending above the expanded part 13, i.e. on the reveal side, is always compressed to a greater extent, in abutment with the window reveal, than the remaining region of the sealing strip 3. As a result, a lower water vapor permeability is achieved in the region 14 than in the remaining region of the sealing strip 3. This is accompanied by the advantages explained in detail in EP 1 811 111 A2, already cited as prior art.

The expansion of the expandable part 13 may be brought about deliberately at any point in time, for instance, as also described further above, by deliberate moistening.

It is also evident here, even though only schematically represented, that certain fragments 12 of the retaining part 4 may also remain abutting against the window reveal 10 after the part has been destroyed by driving through the fixing screw 11. Other fragments 12 fall out.

With respect to FIG. 7, a profiled pocket part 8 is shown on its own. It may be produced as such, with inserted sealing strip 3 and a retaining part 4 as described, and then fitted onto such a window by the manufacturer of a window frame or only on site, for example, snap-connected in place or pushed in. The holding part 4 is a container cover, which is formed to be suitably brittle. By breaking this container cover, the expansion of the foam sealing strip 3 can be released. The container 8 has directly attaching elements, for example, the attaching, pushing-in or snap-fit elements 15 represented.

It may also be formed somewhat smaller than the width of the associated window frame and, for instance, have mounting flanges jutting out longitudinally, for instance for screwing onto a window frame. The part 8 may also be formed for instance for adhesive attachment to the window frame.

With reference to FIG. 8, an embodiment is shown in which the retaining element comprises a film 16. The film 16 is secured by means of attachment projections attached to the outside of the window frame 2, preferably formed integrally with the film 16. The securing may be effected by gluing, also by laminating (placing the film on the window frame and heating until a certain fusing effect occurs) or by tack-welding (tacking). The film can then be opened before or after fitting by active slitting. It may also have predetermined tearing points, preferably running in the longitudinal direction of the window frame, that is to say in the vertical direction with respect to the fitted window, which then bring about complete tearing through, even just by driving through the fixing screws. This may be achieved by a prestressing prevailing in the film 16, as a result of the internal pressure applied by the foam sealing strip 3 and/or as a result of stress introduced in the transverse direction and/or longitudinal direction when mounting the film 16 on the window frame 3.

The embodiment according to FIG. 9 has once again a retaining part 4, which preferably consists of a brittle and possibly biodegradable material, as already described further above. A pertinent aspect here is that the retaining part 4 is secured to the window frame 2, also engaging over the outside, by securing strips 18. It is evident that the securing strips 18 are fixed on the one hand to the retaining part 4, here on the outside, and on the other hand on the window frame 3. With regard to the securing in detail, the measures already described above are suitable, and can in principle also be used directly with regard to the securing between the retaining part 4 and the securing strip 18.

It is not necessary that the securing strips 18 are continuously formed in each case. They may, for example, also be simple adhesive strips applied at a distance from one another. Contrary to the representation in FIG. 9, these may also be provided continuously over the cross-section above the retaining part 4.

In the case of the embodiment of FIG. 10, there is in principle a retaining part 4 as for instance in the embodiment of FIG. 3. A pertinent aspect here is that the securing is provided on the outside of the window frame, here by engaging over the outside by means of latching hooks 19, which engage in a latching opening 20 on the window frame. The material of the retaining part 4 may be formulated such that, in spite of the preferred brittle configuration, this locking over-engagement can be readily carried out as a result of elastic deformation.

The particular retaining parts represented in the embodiments of FIGS. 8 to 10, or the way in which they are mounted, may in each case also be used alternatively or additionally in the case of a profiled pocket part 8 according to FIG. 7.

All features disclosed are (in themselves) pertinent to the invention. The disclosure content of the associated/accompanying priority documents (copy of the prior patent application) is also hereby incorporated in full in the disclosure of the application, including for the purpose of incorporating features of these documents in claims of the present application.

1. A window, comprising:
a window frame; and
that can elastically recover its shape, possibly with a delay, being disposed on the outside of the window frame, the foam being is held in a compressed form on the window frame by means of a retaining part, in that the pre-compression can be released by destructive action on the retaining part disposed such that it is elastically prestressed in the direction of its extent or consists of a brittle material, and, before release, the retaining part secured to the window frame additionally brings about the compression of the foam, which is supported on the other side on the window frame itself.

2. The window as set forth in claim 1, wherein the retaining part is provided as a flexibly formed film which is arranged in a stressed manner and in that the pre-compression can be released by break-up of the retaining part.

3. The window as set forth in claim 1, wherein the retaining part consists of a brittle material and the pre-compression can be released by breaking the retaining part.

4. The window as set forth in claim 1, wherein frame comprises a profiled part.

5. The window as set forth in claim 4, wherein the profiled part has an outwardly opening profiled pocket.

6. The window as set forth in claim 5, wherein the retaining part is connected to the profiled pocket.

7. The window as set forth in claim 5, wherein walls of the profiled pocket serve as retainer holders for the retaining part.

8. The window as set forth in claim 4, wherein the retaining part is adhesively connected to the profiled part.

9. The window as set forth in claim 4, wherein the retaining part is connected to the profiled part by tack-welding.

10. The window as set forth in claim 7, wherein the retaining part is pressed against the retainer holders by the shape recovery force of the foam.

11. The window as set forth in claim 10, wherein the retainer holder comprises a hook-like projection.

12. The window as set forth in claim 1, wherein the retaining part consists of a biodegradable material.

13. The window as set forth in claim 1, wherein the retaining is formed as a plate.

14. A method of fitting a window in a window opening of a structure, the method comprising:
disposing a sealing strip of foam between the window frame and the window opening, the sealing strip elastically recovering its shape after being disposed between the window frame and the window opening;
initially holding the sealing strip on the outside of the window frame, in a compressed state, by means of a retaining part secured to the window;
maintaining the compression by the retaining part together with an associated region of the window; and
after installation of the window in the window opening, releasing the sealing strip by destructive action on the retaining part.

15. The method as set forth in claim 14, further including:
producing the retaining part from a flexible material that is prestressed in the direction of its extent.

16. The method as set forth in claim 14, further including:
producing the retaining part at least partially from a brittle material; and
releasing the sealing strip by breaking the brittle material.

17. The method as set forth in claim 16, wherein step of the breaking of the retaining includes:
placing a mounting screw connecting the window frame to masonry.

18. The method as set forth in claim 14, further including:
Method according to one of claims 14 to 17 or in particular according thereto, characterized in that producing the retaining part at least partially from a biodegradable material.

19. A foam sealing strip suitable for sealing a window frame and impregnated for delayed shape recovery, the foam sealing strip comprising:
two opposite narrow sides, respectively facing the inside or the outside of the window frame in the fitted state, and wide sides, suitable for abutting against the side of a window or the reveal, the narrow sides or narrow side regions being formed differently in such a way that, in the fitted state, the one narrow side has a greater vapor-retarding effect than the other narrow side, the greater vapor-retarding effect being achieved by a higher compression on one side of the foam in the fitted state and the higher compression on one side being achieved by an expansion material associated with this side and provided in addition to the foam, and the additional expansion material being expandable independently of the release of an expansion of the foam sealing strip.

20. The foam sealing as set forth in claim 19, wherein the additional expansion material is disposed in the form of a strip in or under the foam of the foam sealing strip and associated with the desired side.

21. The foam sealing as set forth in claim 19, wherein the additional expansion material is expanded by moistening.

22. The foam sealing as set forth in claim 19, wherein the additional expansion material includes biodegradable material.

23. A method of sealing a window frame with respect to a window reveal by means of a foam sealing strip, which is impregnated for delayed shape recovery, the foam sealing strip having two opposite narrow sides, respectively facing the inside or the outside of the window frame in the state, the method comprising:
abutting wide sides against the side of a window or reveal, it being possible for the narrow sides or narrow side regions to be formed differently in such a way that, in the fitted state, the one narrow side has a greater vapor-retarding effect than the other narrow side, and furthermore the higher compression on one side being achieved by an expansion material associated with this side, provided in addition to the foam and able to expand when expansion is initiated; and
moistening the expansion material for expanding the expansion material independently of the foam strip.

24. The method as set forth in claim 23, wherein the moistening step includes:
moistening the foam of the foam sealing strip.

25. The method as set forth in claim 23, wherein the moistening step includes:
spraying moisture on the expansion material.

26. A foam sealing strip held in a compressed form in a container, the container including:
a container cover, the pre-compression being terminated by destructive action on the retaining part, which is disposed such that it is elastically stressed in its extent or includes of a brittle material.

27. The foam sealing strip as set forth in claim 26, wherein the container includes snap-fit attaching elements.
